(19) United States
(12) Patent Application Publication
(10) Pub. No.: US 2025/0070882 A1
(43) Pub. Date: Feb. 27, 2025

(54) METHOD FOR COHERENT OPTICAL TRANSMISSION AND RECEPTION AND APPARATUS THEREOF

(71) Applicant: ELECTRONICS AND TELECOMMUNICATIONS RESEARCH INSTITUTE, Daejeon (KR)

(72) Inventor: Sun Hyok CHANG, Daejeon (KR)

(21) Appl. No.: 18/776,055

(22) Filed: Jul. 17, 2024

(30) Foreign Application Priority Data
Aug. 21, 2023 (KR) 10-2023-0109022

(51) Int. Cl. H04B 10/516; H04B 10/50; H04B 10/58

(52) U.S. Cl. CPC H04B 10/516; H04B 10/5059; H04B 10/58

(57) ABSTRACT

A method for coherent optical transmission and reception and an apparatus thereof are proposed. The method for operating the apparatus for the coherent optical transmission and reception includes controlling output optical frequencies with a first frequency and a second frequency, generating analog signals respectively corresponding to the first frequency and the second frequency, obtaining beating signals for the analog signals, generating signal diagrams of relationships between a first signal and a second signal on the basis of the beating signals, determining phase differences between the first signal and the second signal on the basis of the signal diagrams, and determining skew values for the first signal and the second signal on the basis of the phase differences.

### CROSS REFERENCE TO RELATED APPLICATION

The present application claims priority to Korean Patent Application No. 10-2023-0109022, filed Aug. 21, 2023, the entire contents of which are incorporated herein for all purposes by this reference.

### BACKGROUND OF THE INVENTION

### Field of the Invention

The present disclosure relates to high-speed signal optical transmission technology and, more particularly, to technology for improving the transmission and reception performance of a high-speed coherent optical transceiver.

### Description of the Related Art

In order to meet the increasing bandwidth demand of high-speed and high-capacity optical networks, high-speed signal optical transmission technology of 400 Gbps or more using a single wavelength has recently been developed. Such high-speed optical transmission uses coherent optical transmission and reception technology, and the development of coherent optical transceivers is being conducted in earnest.

In a paper of the related art, which is titled “Transmitter and receiver impairment monitoring using adaptive multi-layer linear and widely linear filter coefficients controlled by stochastic gradient descent, Optics Express, vol. 29, no. 8, pp. 11548-11561”, skew is monitored and compensated by applying a digital signal processing (DSP) method using a multi-layer digital filter. Such a method has a problem that complexity increases compared to existing DSP algorithms and using the DSP of the related art is difficult.

### SUMMARY OF THE INVENTION

Based on the above-described argument, the present disclosure relates to a technology for improving transmission and reception performance of a coherent optical transceiver for operating at a high symbol rate and a high-order modulation format, and specifically, an objective of the present disclosure is to provide a technology for measuring skew of a coherent optical transceiver, compensating the skew, and improving transmission and reception performance.

According to various exemplary embodiments of the present disclosure, there is provided a method of operating an apparatus for coherent optical transmission and reception, the method including: controlling output optical frequencies with a first frequency and a second frequency; generating analog signals respectively corresponding to the first frequency and the second frequency; obtaining beating signals for the analog signals; generating signal diagrams of relationships between a first signal and a second signal on the basis of the beating signals; determining phase differences between the first signal and the second signal on the basis of the signal diagrams; and determining skew values for the first signal and the second signal on the basis of the phase differences.

In addition, the beating signals may be generated on the basis of differences between the first frequency and the second frequency.

In addition, the first signal may be divided into a 1-1 signal and a 1-2 signal respectively corresponding to a first polarization signal and a second polarization signal for the beating signals, the second signal may be divided into a 2-1 signal and a 2-2 signal respectively corresponding to the first polarization signal and the second polarization signal for the beating signals, and the first polarization signal and the second polarization signal may be perpendicular to each other.

In addition, the signal diagrams may include: a first signal diagram for the 1-1 signal and the 2-1 signal; and the second signal diagram for the 1-2 signal and the 2-2 signal.

In addition, the skew values may be determined on the basis of phase difference values between the first signal and the second signal depending on frequency change of the beating signals.

In addition, the method may further include: identifying four clocks respectively corresponding to the 1-1 signal, the 1-2 signal, the 2-1 signal, and the 2-2 signal on the basis of the skew values; and compensating for the skew values on the basis of the four clocks, wherein the four clocks may have phase values different from each other.

According to the exemplary embodiment of the present disclosure, there is provided an apparatus for coherent optical transmission and reception, the apparatus including: a transceiving unit; and at least one control unit operably connected to the transceiving unit, wherein the at least one control unit is configured to perform a method including: controlling output optical frequencies with a first frequency and a second frequency; generating analog signals respectively corresponding to the first frequency and the second frequency; obtaining beating signals for the analog signals; generating signal diagrams of relationships between a first signal and a second signal on the basis of the beating signals; determining phase differences between the first signal and the second signal on the basis of the signal diagrams; and determining skew values for the first signal and the second signal on the basis of the phase differences.

In addition, the beating signals may be generated on the basis of differences between the first frequency and the second frequency.

In addition, the first signal may be divided into a 1-1 signal and a 1-2 signal respectively corresponding to a first polarization signal and a second polarization signal for the beating signals, the second signal may be divided into a 2-1 signal and a 2-2 signal respectively corresponding to the first polarization signal and the second polarization signal for the beating signals, and the first polarization signal and the second polarization signal may be perpendicular to each other.

In addition, the signal diagrams may include: a first signal diagram for the 1-1 signal and the 2-1 signal; and the second signal diagram for the 1-2 signal and the 2-2 signal.

In addition, the skew values may be determined on the basis of phase difference values between the first signal and the second signal depending on frequency change of the beating signals.

In addition, the at least one control unit may be configured to perform the method further including: identifying four clocks respectively corresponding to the 1-1 signal, the 1-2 signal, the 2-1 signal, and the 2-2 signal on the basis of the skew values; and compensating for the skew values on the basis of the four clocks, wherein the four clocks may have phase values different from each other.

In the apparatus and method according to various exemplary embodiments of the present disclosure, there is proposed a method of measuring IQ skew and compensating for the IQ skew in order to obtain optimal transmission and reception performance in a coherent optical transceiver with a high symbol rate and a high-order modulation format, thereby providing an effect that the optimal transmission and reception performance is able to be obtained.

The effects of the present disclosure are not limited to the above-mentioned effects, and other different effects that are not mentioned will be clearly understood by those skilled in the art from the following description.

### BRIEF DESCRIPTION OF THE DRAWINGS

FIG. 1 is a view illustrating a block diagram of a coherent optical transceiver 101.

FIG. 2 is a view illustrating skews between I-signals and Q-signals and the influence of the IQ skews.

FIG. 3 is a configuration diagram illustrating the operation of an apparatus for coherent optical transmission and reception according to an exemplary embodiment of the present disclosure.

FIG. 4 is a view illustrating each IQ diagram of a Q signal relative to an I signal in a case where there is no IQ skew in signals obtained by the apparatus for the coherent optical transmission and reception according to the exemplary embodiment of the present disclosure.

FIG. 5 is a view illustrating each IQ diagram of a Q signal relative to an I signal in a case where there exists IQ skew in signals obtained by the apparatus for the coherent optical transmission and reception according to the exemplary embodiment of the present disclosure.

FIG. 6 is a view illustrating an example in which phase differences of signals obtained by the apparatus for the coherent optical transmission and reception according to the exemplary embodiment of the present disclosure change linearly depending on beating frequencies.

FIG. 7 is a configuration diagram illustrating the operation of an apparatus for coherent optical transmission and reception according to another exemplary embodiment of the present disclosure.

FIG. 8 is a flowchart illustrating the operation of the apparatus for the coherent optical transmission and reception according to the exemplary embodiment of the present disclosure.

### DETAILED DESCRIPTION OF THE INVENTION

The terms used in the present disclosure are only used to describe a specific exemplary embodiment, and may not be intended to limit the scope of other exemplary embodiments. As used herein, the singular forms may include the plural forms as well, unless the context clearly indicates otherwise. The terms including technical and scientific terms used herein have the same meaning as commonly understood by one of those skilled in the art described in the present disclosure. Among the terms used in the present disclosure, terms defined in a general dictionary may be interpreted as having the same or similar meaning as the meaning in the context of the related art, and are not interpreted in an ideal or excessively formal meaning unless explicitly defined in the present disclosure. In some cases, even the terms defined in the present disclosure may not be interpreted to exclude the exemplary embodiments of the present disclosure.

In various exemplary embodiments of the present disclosure described below, a hardware approach method is described as an example. However, since the various exemplary embodiments of the present disclosure include technology using both hardware and software, the various exemplary embodiments of the present disclosure do not exclude a software-based approach method.

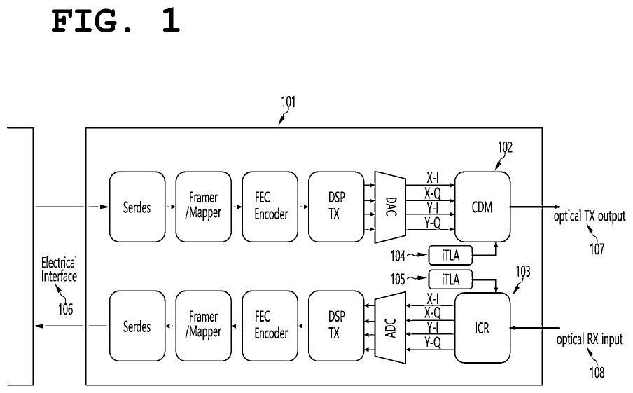

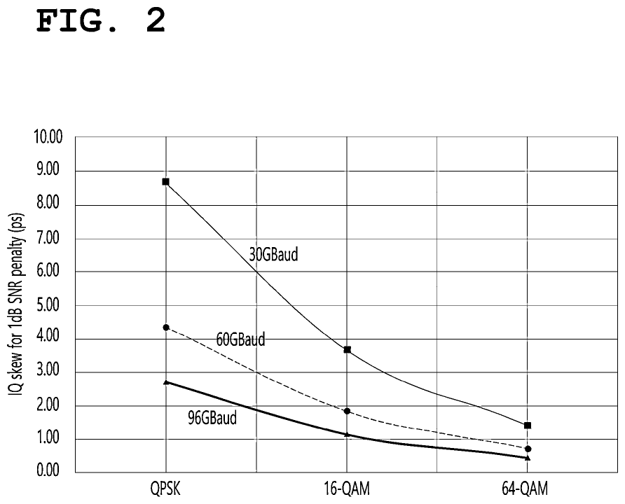

First, the related art of the present disclosure will be described with reference to FIGS. 1 and 2.

FIG. 1 is a view illustrating a configuration diagram of a coherent optical transceiver 101.

Referring to FIG. 1, the coherent optical transceiver 101 uses, as an optical transmitter and an optical receiver, a coherent driver modulator (CDM) 102 for converting an electrical signal into an optical output and an integrated coherent receiver (ICR) 103 for converting an optical input into an electrical signal, respectively. In FIG. 1, an integrated tunable laser assembly (iTLA) 104 may correspond to an optical carrier of the optical transmitter, and an iTLA 105 may correspond to a light source used as a local oscillator (LO) of the optical receiver.

A signal, which is input through an electrical interface 106, may pass through a serializer/deserializer (Serdes), and then pass through a framer/mapper. To this end, a signal frame of Ethernet or optical transport network (OTN) may be used. Thereafter, a signal may be formed in a digital signal processing (DSP) TX block through a forward error correction (FEC) encoder. In the DSP TX block, bit mapping and pilot, training symbol insertion, and the like are performed in accordance with a modulation format.

An in-phase (I) signal and a quadrature (Q) signal are respectively generated two for mutually perpendicular polarizations X and Y, so four signals, i.e., X-I, X-Q, Y-I, and Y-Q signals, are formed, and may be converted by using four high-speed digital-to-analog converters (DACs) and input to the CDM 102. The optical signal modulated in the CDM 102 may be output as an optical TX output 107.

An optical RX input 108 received may be converted into an electrical signal in the ICR 103. In this case, the ICR outputs four signals: X-I, X-Q, Y-I, and Y-Q, and the four output signals are respectively converted into digital signals in four analog-to-digital converters (ADCs), and then may be recovered in a DSP RX block. In the DSP RX block, digital signal processing such as clock recovery, polarization separation, frequency offset estimation, and carrier phase recovery may be performed. In addition, signal recovery is performed in accordance with the modulation format, and may be converted to bit values. Thereafter, error recovery may be proceeded by passing through a FEC decoder. In a framer/mapper, deframing/demapping may be performed, that is, payload may be separated from a signal frame, and then transmitted to an electrical interface 106 through a Serdes.

As shown in FIG. 1, signals connected and transmitted to the CDM 102 and the ICR 103 may have the respective four signals: X-I, X-Q, Y-I, and Y-Q. As a modulation rate increases and the modulation format becomes more complex with higher order, the influence with respect to the relative skew of the four signals may appear greater. When a coherent optical transceiver is manufactured, skew values may be determined by path differences between the X-I, X-Q, Y-I, and Y-Q signals.

FIG. 2 is a view illustrating skews between I-signals and Q-signals and the influence of the IQ skews.

Specifically, FIG. 2 shows IQ skew values that cause an SNR penalty of 1 dB as a symbol rate increases to 30, 60, and 96 GBaud. In QPSK modulation, the IQ skew values are 8.7, 4.3, and 2.7 ps at respective symbol rates. On the other hand, in 64 QAM modulation, the IQ skew values are 1.4, 0.7, and 0.4 ps. That is, it may be confirmed that as the symbol rate increases and the modulation format has higher order, the penalty due to the skew increases. Accordingly, in a high-speed symbol rate and high-order modulation format, better transmission and reception performance is attainable only when skew is corrected with sub-ps accuracy.

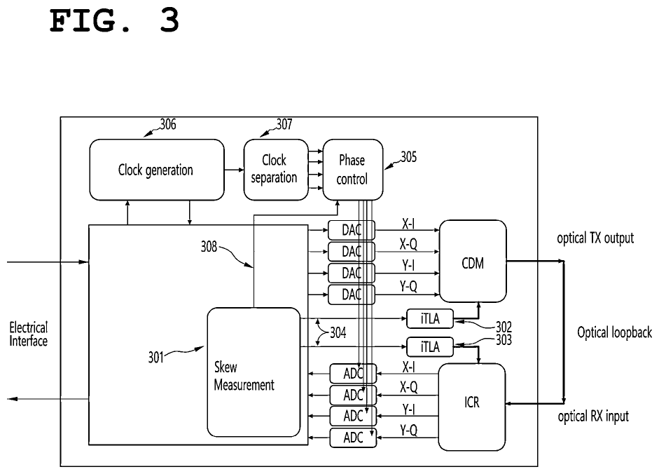

FIG. 3 is a configuration diagram illustrating the operation of an apparatus for coherent optical transmission and reception according to the exemplary embodiment of the present disclosure.

The apparatus for the coherent optical transmission and reception may be composed of a plurality of functional blocks. FIG. 3 specifically shows connection and arrangement relationships between different functional blocks, focusing on the operation of a skew measurement unit 301 among the plurality of functional blocks. The apparatus for the coherent optical transmission and reception may also be referred to as a coherent optical transceiver.

In addition, among the different functional blocks shown in FIG. 1, functions not shown in FIG. 3 may be functions in an inactivated state. First, the present disclosure will describe a process of obtaining skew through skew measurement by the skew measurement unit 301 and applying this skew to improve transmission and reception performance.

The skew measurement unit 301 may control output optical frequencies of the iTLA 302 and the iTLA 303 through signals 304, so that a difference between the two frequencies is changeable. For example, when the iTLA 302 is set to use 193 THz (i.e., 1553.329 nm) and the iTLA 303 is set to use 193.002 THz (i.e., 1553.313 nm), a frequency difference may be 2 GHz. In this case, the CDM may also be deactivated so as not to perform modulation.

When such optical signals are received by the ICR, beating signals are received due to the frequency differences, and converting to digital signals is performed in the ADCs. An I signal and a Q signal are 90 degrees different from each other, and after passing through the ADCs, the Q signal relative to the I signal may be represented in an IQ diagram.

Specifically, an IQ diagram is drawn in a complex plane, where a horizontal axis may represent an I signal and a vertical axis may represent a Q signal. Here, the in-phase (I) signal is a signal that has the same phase as a given reference signal, and may be displayed on the horizontal axis and generally represented in X polarization, and the quadrature (Q) signal is a signal that is 90 degrees out of phase with the given reference signal, and may be displayed on the vertical axis and generally represented in Y polarization. A position of each point may be understood as a complex representation of I and Q values corresponding to a specific time. In coherent optical transmission, the IQ diagram provides the complex plane representation of the I and Q signals and may be used for modulation, demodulation, polarization control, signal quality analysis, etc.

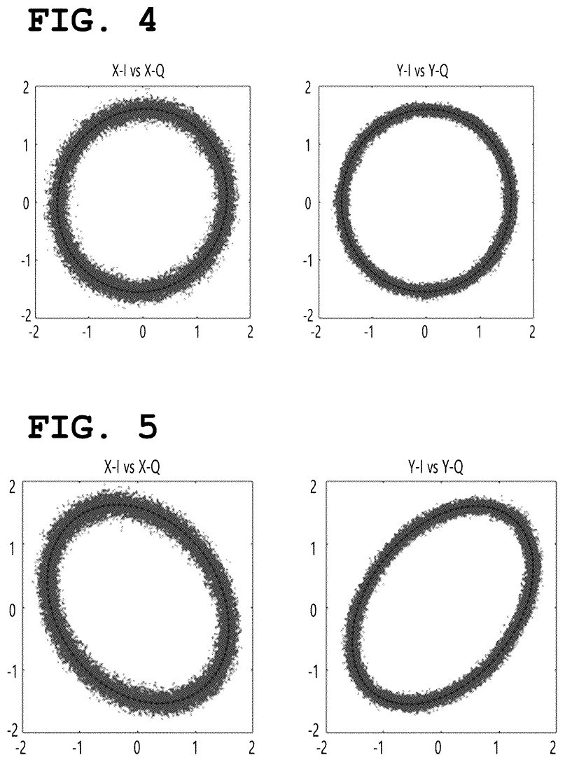

FIG. 4 is a view illustrating each IQ diagram of a Q signal relative to an I signal in a case where there is no IQ skew in signals obtained by the apparatus for the coherent optical transmission and reception according to the exemplary embodiment of the present disclosure. FIG. 5 shows each IQ diagram of a Q signal relative to an I signal in a case where there exists IQ skew.

In the case of no IQ skew, each IQ diagram may appear as a perfect circle as shown in FIG. 4. In contrast, in the case where there is IQ skew, each IQ diagram may have the shape of an ellipse as shown in FIG. 5 when there is a frequency difference. From the shape of this ellipse, the phase difference between the I signal and the Q signal may be obtained. The phase difference between the I-signal and Q-signal obtained in this way may change linearly depending on beating frequencies in a case where there is skew.

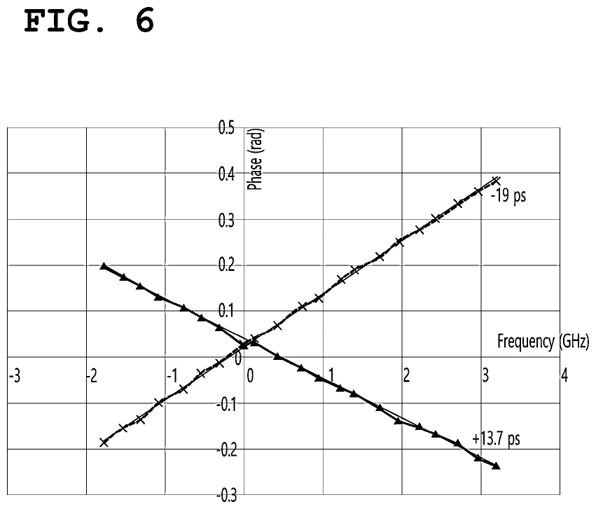

FIG. 6 is a view illustrating an example in which a phase difference of signals obtained by the apparatus for the coherent optical transmission and reception according to the exemplary embodiment of the present disclosure changes linearly depending on beating frequencies.

In a case where IQ skews are −19 and +13.7 ps, respectively, FIG. 6 shows phase difference values obtained with respect to the beating frequencies. A slope of each straight line obtained here may be expressed as an equation below.

IQ skew=a slope of a straight line/(2*pi)

In this way, the IQ skew values may be measured. By calculating the skew of X-I and Y-I in the same way, the skew between X and Y may also be measured. The skew is able to be measured in the manner as described above, which is performed through digital signal processing in the skew measurement unit 301.

The skew values measured in this way may be transmitted to a phase control unit 305 through a signal 308. The phase control unit 305 may control respective phases of the four clocks branched from the clock generation unit 306 and the clock separation unit 307. These four clocks are connected to sampling clocks of ADCs, and the sampling timing of the ADCs may be set differently from each other by using clocks having four phase values different from each other. By varying the phases of the sampling clocks to be different from each other, a delay that may compensate for the skew obtained in the skew measurement unit 301 may be provided.

After the phases of the sampling clocks are adjusted by the phase control unit 305 and the skew is compensated, the outputs of the ADCs are reconnected to the DSP RX block as shown in FIG. 1, and switching may be performed so that signal processing of the received signals may proceed.

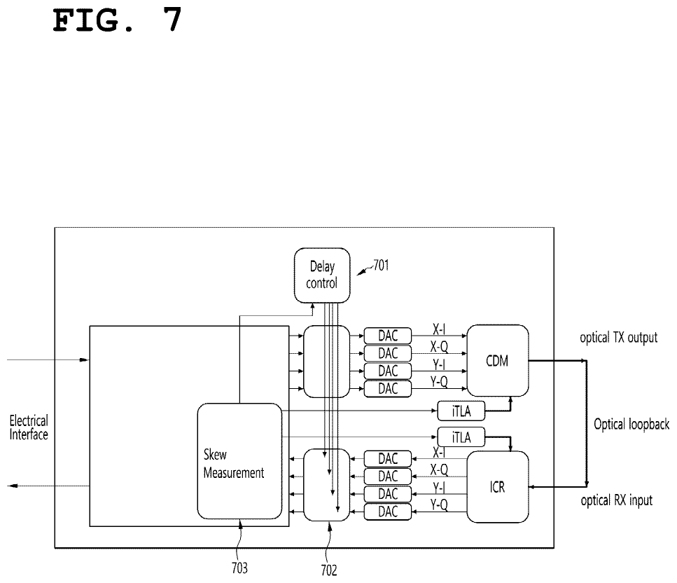

FIG. 7 is a configuration diagram illustrating the operation of an apparatus for coherent optical transmission and reception according to another exemplary embodiment of the present disclosure.

The operation of a skew measurement unit 703 may be the same as that shown in FIG. 3. The skew measurement unit 703 may measure skew values and then transmit the skew values to a delay control unit 701. Delay values are transmitted to a digital interpolator 702 in connection, and the skew of each of the four signals may be applied. The method shown in FIG. 3 is the method of directly controlling the sampling clocks, but a method shown in FIG. 7 may be understood as a method of compensation by applying the skew values in a digital domain.

In a state where the skew is compensated by the delay control unit 701, the outputs of ADCs are connected back to a DSP RX block through the digital interpolator as shown in FIG. 1, and switching may be performed so that the signal processing of the received signals may proceed.

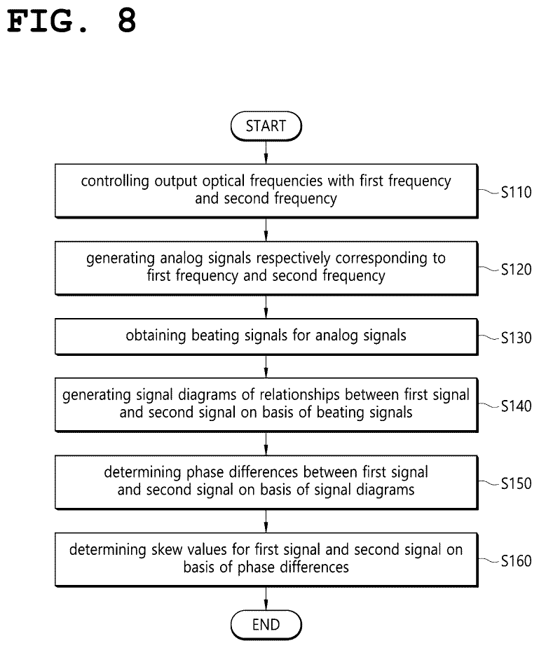

FIG. 8 is a flowchart illustrating the operation of the apparatus for the coherent optical transmission and reception according to the exemplary embodiment of the present disclosure.

In step S110, a coherent optical transceiver controls output optical frequencies with a first frequency and a second frequency. The above operation may be performed in a skew measurement unit.

In step S120, the coherent optical transceiver generates analog signals respectively corresponding to the first frequency and the second frequency.

In step S130, the coherent optical transceiver obtains beating signals for the analog signals. Here, the beating signals may be generated on the basis of differences between the first frequency and the second frequency.

In step S140, the coherent optical transceiver generates signal diagrams of relationships between the first signal and the second signal on the basis of the beating signals.

Here, the first signal may be divided into a 1-1 signal and a 1-2 signal respectively corresponding to a first polarization signal and a second polarization signal for the beating signals.

In addition, the second signal may be divided into a 2-1 signal and a 2-2 signal respectively corresponding to the first polarization signal and the second polarization signal for the beating signals.

In the exemplary embodiment, the first polarization signal and the second polarization signal may be perpendicular to each other.

In addition, the signal diagrams may include: a first signal diagram for the 1-1 signal and the 2-1 signal; and the second signal diagram for the 1-2 signal and the 2-2 signal.

In step S150, the coherent optical transceiver determines phase differences between the first signal and the second signal on the basis of the signal diagrams.

In step S160, the coherent optical transceiver determines skew values for the first signal and the second signal on the basis of the phase differences.

Here, the skew values may be determined on the basis of phase difference values between the first signal and the second signal depending on frequency change of the beating signals.

In addition, the coherent optical transceiver may be configured to identify four clocks respectively corresponding to the 1-1 signal, the 1-2 signal, the 2-1 signal, and the 2-2 signal on the basis of the skew values, and compensate for the skew values on the basis of the four clocks. Here, the four clocks may have phase values different from each other.

The methods according to the exemplary embodiments described in the claims or specification of the present disclosure may be implemented in the form of hardware, software, or a combination of hardware and software.

When implemented in software, a computer readable storage medium for storing one or more programs (i.e., software modules) may be provided. One or more programs stored in the computer-readable storage medium are configured for execution by one or more processors in an electronic device. One or more programs include instructions that cause the electronic device to execute the methods according to the exemplary embodiments described in the claims or specification of the present disclosure.

In the specific exemplary embodiments of the present disclosure described above, the components included in the disclosure are expressed in singular or plural numbers according to the specific exemplary embodiments presented. However, the singular or plural expressions are selected appropriately for the presented situation for convenience of description, and the present disclosure is not limited to the singular or plural components. Even components expressed in plural may be composed of a single component, or even a component expressed in a singular number may be composed of a plurality of components.

Meanwhile, in the detailed description of the present disclosure, specific exemplary embodiments have been described, but various modifications may be made without departing from the scope of the present disclosure. Therefore, the scope of the present disclosure should not be limited to the exemplary embodiments described above, but should be defined not only by the scope of claims described later, but also by those equivalent to the scope of these claims.

What is claimed is:

1. A method of operating an apparatus for coherent optical transmission and reception, the method comprising:
controlling output optical frequencies with a first frequency and a second frequency;
generating analog signals respectively corresponding to the first frequency and the second frequency;
obtaining beating signals for the analog signals;
generating signal diagrams of relationships between a first signal and a second signal on the basis of the beating signals;
determining phase differences between the first signal and the second signal on the basis of the signal diagrams; and
determining skew values for the first signal and the second signal on the basis of the phase differences.

2. The method of claim 1, wherein the beating signals are generated on the basis of differences between the first frequency and the second frequency.

3. The method of claim 1, wherein the first signal is divided into a 1-1 signal and a 1-2 signal respectively corresponding to a first polarization signal and a second polarization signal for the beating signals,
the second signal is divided into a 2-1 signal and a 2-2 signal respectively corresponding to the first polarization signal and the second polarization signal for the beating signals, and
the first polarization signal and the second polarization signal are perpendicular to each other.

4. The method of claim 3, wherein the signal diagrams comprise:
a first signal diagram for the 1-1 signal and the 2-1 signal; and
the second signal diagram for the 1-2 signal and the 2-2 signal.

5. The method of claim 1, wherein the skew values are determined on the basis of phase difference values between the first signal and the second signal depending on frequency change of the beating signals.

6. The method of claim 1, further comprising:
identifying four clocks respectively corresponding to the 1-1 signal, the 1-2 signal, the 2-1 signal, and the 2-2 signal on the basis of the skew values; and
compensating for the skew values on the basis of the four clocks,
wherein the four clocks have phase values different from each other.

7. An apparatus for coherent optical transmission and reception, the apparatus comprising:
a transceiving unit; and
at least one control unit operably connected to the transceiving unit,
wherein the at least one control unit is configured to perform a method comprising:
controlling output optical frequencies with a first frequency and a second frequency;
generating analog signals respectively corresponding to the first frequency and the second frequency;
obtaining beating signals for the analog signals;
generating signal diagrams of relationships between a first signal and a second signal on the basis of the beating signals;
determining phase differences between the first signal and the second signal on the basis of the signal diagrams; and
determining skew values for the first signal and the second signal on the basis of the phase differences.

8. The apparatus of claim 7, wherein the beating signals are generated on the basis of differences between the first frequency and the second frequency.

9. The apparatus of claim 7, wherein the first signal is divided into a 1-1 signal and a 1-2 signal respectively corresponding to a first polarization signal and a second polarization signal for the beating signals,
the second signal is divided into a 2-1 signal and a 2-2 signal respectively corresponding to the first polarization signal and the second polarization signal for the beating signals, and
the first polarization signal and the second polarization signal are perpendicular to each other.

10. The apparatus of claim 9, wherein the signal diagrams comprise:
a first signal diagram for the 1-1 signal and the 2-1 signal; and
the second signal diagram for the 1-2 signal and the 2-2 signal.

11. The apparatus of claim 7, the skew values are determined on the basis of phase difference values between the first signal and the second signal depending on frequency change of the beating signals.

12. The apparatus of claim 7, wherein the at least one control unit is configured to perform the method further comprising:
identifying four clocks respectively corresponding to the 1-1 signal, the 1-2 signal, the 2-1 signal, and the 2-2 signal on the basis of the skew values; and
compensating for the skew values on the basis of the four clocks,
wherein the four clocks have phase values different from each other.
